(19) United States
(12) Patent Application Publication
(10) Pub. No.: US 2026/0148141 A1
(43) Pub. Date: May 28, 2026

(54) WEARABLE ALGORITHM FOR RAPID FALL DETECTION

(71) Applicant: REHABILITATION INSTITUTE OF CHICAGO, Chicago, IL (US)

(72) Inventors: Kyle Embry, Chicago, IL (US); Arun Jayaraman, Chicago, IL (US); Jonathan Mendley, Potomac, MD (US)

(73) Assignee: REHABILITATION INSTITUTE OF CHICAGO, Chicago, IL (US)

(21) Appl. No.: 19/400,506

(22) Filed: Nov. 25, 2025

Related U.S. Application Data
(60) Provisional application No. 63/724,483, filed on Nov. 25, 2024.

(51) Int. Cl. G06N 20/00; G06F 1/16

(52) U.S. Cl. CPC G06N 20/00; G06F 1/163

(57) ABSTRACT

A system for pre-fall detection and mitigation includes: at least one wearable sensor device attached noninvasively to a patient, the sensor device continuously generating new sensor data associated with the user; at least one fall impact mitigation device attached noninvasively to the user; and a data system comprising a database and at least one data processing device. The data processing device collects historical laboratory-collected data and historical community-collected data associated with other users from the database, trains and validates at least one predictive model based on the historical laboratory-collected data and historical community-collected data, extracts features from the new sensor data received from the sensor device, predicts, using the trained and validated model, a fall event based on the extracted features, generates instructions to deploy a fall impact mitigation device, and transmits the instructions to the fall impact mitigation device.

### CROSS REFERENCE TO RELATED APPLICATION

The present application claims the benefit of U.S. Application No. 63/724,483, filed Nov. 25, 2024, the disclosure of which is incorporated herein by reference in its entirety for all purposes.

### GOVERNMENT SUPPORT CLAUSE

This invention was made with government support under Grant No. RERC #90REG E0003 awarded by National Institute on Disability, Independent Living, and Rehabilitation Research (NIDILRR). The government has certain rights in the invention.

### FIELD

The present disclosure relates generally to pre-fall detection systems. More specifically, the disclosure relates to pre-fall detection systems that implement wearable airbags and improved fall-detection algorithms using machine-learning techniques trained on both in-laboratory and real-world fall data.

### BACKGROUND

Globally, falls are a major public health problem. Some populations experience falls at higher incidence. For example, falls are one of the most common medical complications experienced by individuals after a stroke, reported in up to 65% of the stroke population during hospitalization and up to 75% in the community. Every year, approximately 13 million individuals around the world experience a stroke. Individuals who have experienced a stroke are at an increased vulnerability for falling, related to common correlates of high fall risk in this population such as impaired mobility, medication use, and cognitive impairment. Falls are also the leading cause of injury among older adults—those aged 65 and older—in the United States. In the US alone, there were 3 million emergency department visits in 2015 due to older adult falls. In 2019, 88% of emergency department visits and hospitalizations for hip fractures were caused by falls. Further, around 60% of people with Parkinson's disease (PD) fall every year. PD, the second most common neurodegenerative disorder, affects about 1 million people in the U.S., with over 90,000 new diagnoses each year. Risk factors for falls in PD that have been identified include freezing of gait (FOG), cognitive impairment, poor leaning balance, previous falls, lower limb weakness and slow gait speed. PD patients are twice as likely to fall compared to those with other neurological disorders. Additionally, in the US, about 150,000 people each year undergo a lower-limb amputation and more than half of all amputees experience at least one fall each year. In summary, most neurological conditions and gait impairments lead to increased risk of falls and fall injuries.

In these and other high-risk populations, falling can have serious consequences. Physically, falls result in a high incidence of severe physical injuries, including fractures, soft tissue and head injuries, and at worst, death. Psychologically, individuals often develop a fear of falling, leading to reduced mobility, increased social isolation, and significant reduction in quality of life. Financially speaking, fall-related injuries constitute a burden on healthcare systems through prolonged use of services and incurred high healthcare costs.

Exercise and medication interventions have had limited success in preventing falls. Therefore, individuals who suffer from mobility deficits and neurological impairments, including post-stroke individuals or those with PD, continue to experience falls, frequently and repeatedly. Without a way to prevent these falls from occurring, there is a compelling need to develop methods and tools to detect these falls before impact with the ground and mitigate the associated consequences.

Solutions to achieve some degree of fall impact mitigation have been proposed, including wearing padded hip protectors in or underneath clothing and wearable airbag technology. However, with insignificant usage in the community (likely due to discomfort and poor compliance), the significance of wearable padding in reducing fractures and associated injuries due to falls is limited. Despite continued development, wearable airbag technologies are not only developed with the non-neurologically impaired older adult population in mind, but the internal fall impact detection algorithms are often developed on data from young participants, without stroke, PD or other motor or neurological impairments. The design and computational models currently underlying these devices do not seamlessly transfer to users in the stroke or PD population who present with characteristic changes in movement kinematics and a loss of ability to control movements. Significantly, these changes in movement may translate to observed and measurable differences leading up to or during falls. Moreover, existing fall-detection algorithms are almost exclusively trained on in-laboratory simulated fall data and do not always perform well on real-world falls.

As such, there is a need for a fall impact mitigation system using a wearable concealed airbag system built on a pre-fall detection algorithm that is trained on data from populations with neurological or movement impairments, such as post-stroke individuals or those with PD. Further, a need exists for a pre-fall detection algorithm trained on movement and fall data collected in both the laboratory and the community.

### SUMMARY

Disclosed herein are novel pre-fall detection and mitigation systems for individuals with neurological and movement impairments, using machine-learning techniques trained on both in-laboratory and real-world fall and movement data. A pre-fall detection system includes: at least one wearable sensor device attached noninvasively to a user and configured to continuously generate new sensor data associated with the user; at least one data processing device configured to execute a predictive model configured to predict a fall event based at least on the sensor data; and an inflatable airbag device worn by the user configured to deploy upon prediction of a fall event by the predictive model and mitigate contact forces with the ground. The wearable sensor device may be provided as an inertial measurement unit (IMU). The data processing device is configured to: collect historical laboratory-collected movement data and historical community-collected movement data associated with other users of the system; train and validate the at least one predictive model based on the historical laboratory-collected movement data and historical community-collected movement data; extract features from the new sensor data received from the sensor device; predict, using the trained and validated model, a fall event based on the extracted features; and cause the inflatable airbag to deploy upon prediction of a fall event.

Also disclosed herein are methods, such as computer-implemented methods, for pre-fall detection and mitigation. The method includes: collecting historical laboratory-collected movement data and historical community-collected movement data associated with other users of a pre-fall detection system; training and validating at least one predictive model based on the historical laboratory-collected movement data and historical community-collected movement data; extracting features from new sensor data received from at least one wearable sensor device attached noninvasively to a user, the sensor device configured to continuously generate the new sensor data associated with the user; predicting, using the trained and validated model, a fall event based on the extracted features; and causing an inflatable airbag worn by the user to deploy upon prediction of a fall event. Further disclosed herein are non-transitory computer readable media storing computer program instructions that, when executed by a processor, cause the processor to perform the aforementioned computer-implemented methods.

The foregoing examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the embodiments of the disclosure and are incorporated in and constitute a part of this specification, illustrate examples, and together with the description serve to explain the principles of the disclosure.

FIG. 1 is a schematic diagram of a pre-fall detection and mitigation system according to embodiments disclosed herein;

FIG. 2 is a block diagram of the processing device as implemented in the patient health monitoring and assessment system according to embodiments disclosed herein;

FIGS. 3A and 3B are illustrations of an exemplary wearable airbag device as viewed from two different angles according to embodiments disclosed herein;

FIG. 4 is a graphic illustrating falling and non-falling activities according to embodiments disclosed herein;

FIG. 5 is a graph of acceleration data gathered from a sensor on the wearable device according to embodiments disclosed herein; and

FIG. 6 is a flow chart of a process performed by a processing device in the pre-fall detection system according to embodiments disclosed herein.

It should be understood that some of the drawings and replicas of the photographs may not necessarily be shown to scale, unless otherwise indicated. In certain instances, details that are not necessary for an understanding of the disclosure or that render other details difficult to perceive may have been omitted. It should be understood, of course, that the disclosure is not necessarily limited to the particular examples or embodiments illustrated or depicted herein.

### DETAILED DESCRIPTION

### Definitions and Terminology

This disclosure is not meant to be read in a restrictive manner. For example, the terminology used in the application should be read broadly in the context of the meaning those in the field would attribute such terminology. Persons skilled in the art will readily appreciate that the various embodiments of the inventive concepts provided in the present disclosure can be realized by any number of methods and apparatuses configured to perform the intended functions. It should also be noted that the accompanying figures referred to herein are not necessarily drawn to scale, but may be exaggerated to illustrate various aspects of the present disclosure, and in that regard, the figures should not be construed as limiting. Some figures do, however, represent anatomy and the positioning of embodiments relative to that anatomy and such representations should be understood to be scaled and positioned accurately, with some deviation permitted as the anatomical structures depicted will vary in size and position from person to person.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀).

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### Description of Various Embodiments

The present disclosure relates to systems, devices, and methods for pre-fall detection and mitigation using one or more movement sensors and a wearable airbag device that are wearably or noninvasively attached to the patient's body, as further explained herein. Falls are a common complication experienced after a stroke, amongst individuals with PD, and amongst older adults, and can cause serious detriments to physical health and social mobility, necessitating a dire need for intervention. Among recent advancements, wearable airbag technology has been designed to detect and mitigate fall impact. However, these devices have not been designed nor validated for the stroke or PD populations and, thus, may not adequately detect falls in individuals with neurological and/or motor impairments. The underlying pathophysiology of a stroke or PD may manifest with alterations in movement kinematics and an inability or loss of ability to control movements. These characteristic changes or differences in movement, as compared to young and neuro-normative individuals, have been observed and quantified in existing literature and may translate to observed and measurable differences leading up to or during falls. For example, earlier studies have analyzed and compared falls between older able-bodied and stroke individuals, and found significantly different motor responses including postural stability, trunk control, fall velocity, and timely step compensation. Furthermore, it has also been found that within a stroke population, kinematic responses differed depending on the side of the body which a fall was initiated on (paretic vs. non-paretic). Given that falls in stroke or PD individuals may have distinct kinematic profiles, current fall mitigation technology developed on data of generally healthy individuals might not be sufficiently sensitive or specific to detect falls in individuals who have experienced a stroke. Such inaccuracy could result in failure to deploy the airbag during a fall or cause unnecessary airbag deployments (i.e. false positives) and consequently, may lead to poor user engagement.

Moreover, most commonly, wearable airbag technology has only been designed and validated on laboratory-collected fall and movement data and, therefore, may not reflect real-world conditions. In the real world, falls are inherently unexpected events, and the human nervous system reacts in an automatic fashion to the unexpected sensation of falling. In a laboratory setting, it is very difficult to replicate the exact same falling response because the participant has at least some expectation that they will fall. This allows the participant to “prepare” to fall, which can change their movement and response to the fall. These changes in reaction to the fall can also change the sensor readings recorded during in-laboratory falls, as compared to real-world falls. For these reasons, algorithms trained on expected fall data in a laboratory are not as accurate when provided unexpected, real-world fall response data.

To address this, an improved fall-detection and mitigation system is disclosed herein. The system includes processes that are applied together or separately to: (1) accurately predict real-world falls in individuals, particularly those with mobility deficits and neurological impairments, such as in the post-stroke and PD populations, (2) deploy wearable airbag(s) to mitigate injuries from fall impact; and (3) refine prediction model(s) based on further real-world data collection. The system as disclosed herein may leverage noninvasive body-worn sensors for continuous collection of movement data and body-worn airbag devices to reduce risk of fall-related fractures and injuries and ease fear of falling, thereby improving overall health and quality of life in at-risk populations. The system may use signal processing and machine learning to analyze movement data collected from the sensors, extract features indicative of falling, and predict falls under real-world conditions.

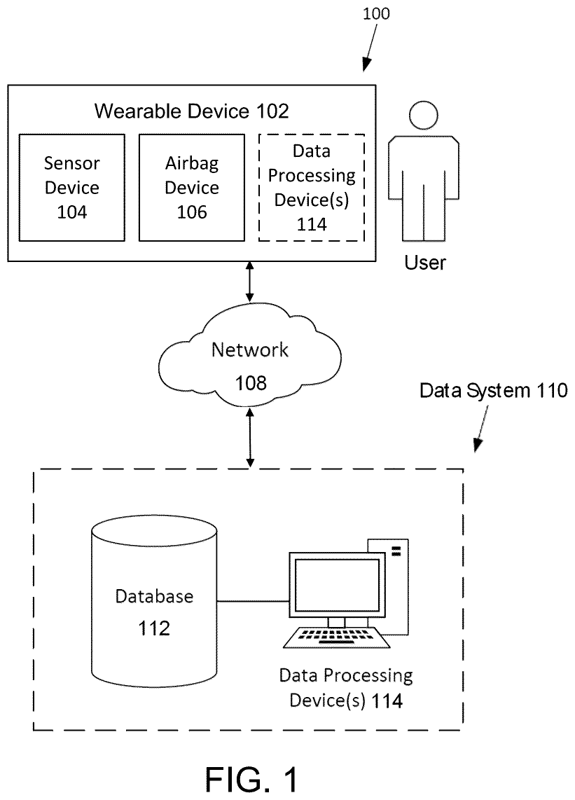

FIG. 1 shows an example of a system 100 for pre-fall detection and mitigation that is configured to continuously collect movement data from a sensor worn on a patient or user and, through a predictive model trained on previously-collected real-world and laboratory-collected movement and fall data, predict a fall and deploy a wearable airbag to mitigate fall-related injuries. The system 100 includes a patient or user as well as a wearable device 102, which may include at least one sensor device 104 and at least one airbag device 106 wearably attached to the body of each patient. Although the sensor device 104 and wearable airbag device 106 are illustrated as being contained within the wearable device 102, it is to be understood that the sensor device 104 and airbag device 106 may be provided separately. The sensor device 104 may be any suitable wearable sensor device that can be attached noninvasively to a user, and the sensor device continuously generates new sensor data associated with the user. The sensor device 104 may include one or more movement sensors. In some examples, the sensor data includes one or more types of biometric or activity data. In some examples, the sensor device 104 may be provided as one or more inertial measurement units (IMU) sensors. The biometric or activity data may include motion data from one or more IMUs.

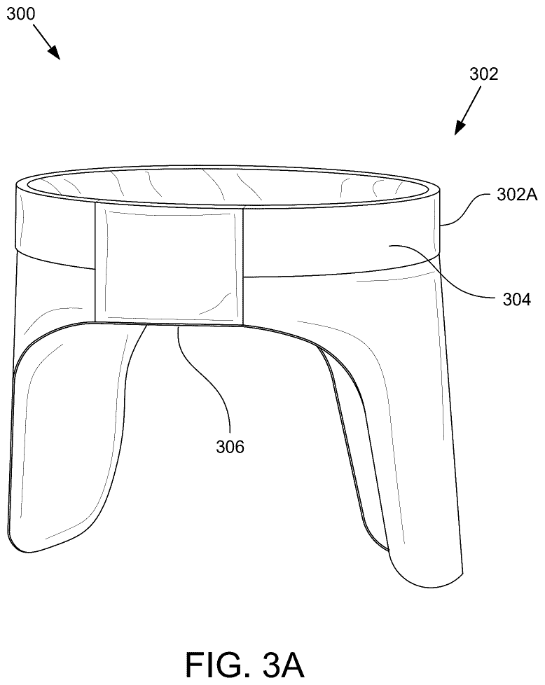

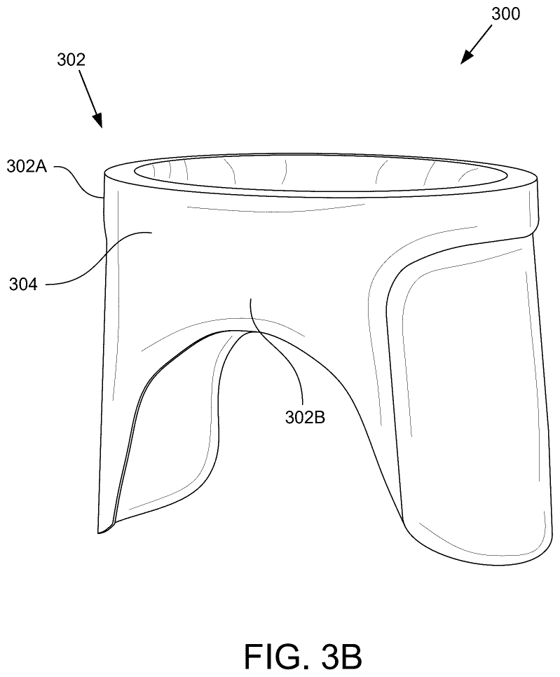

FIGS. 3A and 3B show a hip-protection wearable airbag device 300, which is an example of a wearable device 102 that includes one or more sensor devices 104. The sensor devices 104 may include a plurality of fixed IMU sensors 302. In some examples, there may be three IMU sensors 302, one each positioned on the lateral sides of the hips (e.g., IMU sensor 302A) and one on the lower back aligned with the L3 vertebrae (e.g., IMU sensor 302B). Each IMU sensor 302 may contain an accelerometer (range ±16 g) and gyroscope sensor (range ±2000 deg/s) collecting data in all three axes (x, y, and z) at a sampling rate of 500 Hz.

The airbag device 106 may be provided as one or more devices configured to protect the hips, head, shoulders, trunk, or other areas prone to fall-related injury. The airbag device 106 may include at least one fall impact mitigation device attached noninvasively to the user such that the fall impact mitigation device is any device suitable for mitigating the impact of a fall to the user. In some examples, the airbag device may be worn over or under clothes and may be provided as a belt, shorts, vest, jacket or other form. In one example, the airbag device 106 is provided as a Wolk Hip Airbag (Wolk De Heupairbag; Wolk Company, Netherlands), a commercial airbag system designed to wear underneath clothing. The airbag device 106 may include a power source, such as a battery, an onboard computing unit 306, one or more expandable air chambers, and one or more inflation elements, such as CO₂ cartridges 304, for filling the air chambers.

In one example, the wearable device 102 is communicably coupled with one or more networks 108 which may be any type of network, including a secured network, that allows for communication between the wearable device 102 and the data system 110. In some embodiments, the network 108 can include one or more of:
a local area network (LAN), wide area network (WAN), the Internet, cloud network, cellular network, mesh network, peer-to-peer (P2P) communication link and/or some combination thereof and can include any number of wired or wireless links. Communication over the network 108 can be accomplished, for instance, via a network interface using any type of protocol, protection scheme, encoding, format, and/or packaging, as suitable, to preserve patient data privacy and security. Also communicably coupled with the network 108 is a data system 110 that includes a database 112 (e.g., a remote server) that stores thereon information associated with past and current users, and a data processing device(s) 114 that is operably coupled with the database 112, such that the database 112, the data processing device(s) 114, and the wearable device(s) 102 may all be located at different locations separate from each other. While FIG. 1 depicts a data system 110 which includes the database 112 and data processing device 114 remote from the wearable device 102, it is understood herein that a data system 110 or any component thereof, such as the database 112 and/or data processing device 114, may also be provided integrally with the wearable device 102. For example, in some embodiments, one or more data processing devices 114 may also be provided integrally with the wearable device 102 along with the sensor device 104 and the airbag device 106. The at least one data processing device 114 of the data system 110 may be referred to as “first data processing device”, and the at least one data processing device 114 of the wearable device 102 may be referred to as “second data processing device”.

The system 100 may also include a memory, such as a SD card, on the wearable device 102 for storing data collected by the sensor device 104. In further embodiments, the wearable device 102 may be communicably coupled with a user device, which may receive and store data from the sensor device 104. In some examples, the sensor device 104 may transmit the sensor data to the user devices via a wired connection or via a wireless connection such as using radiofrequency, including but not limited to Bluetooth, radiofrequency identification (RFID), near-field communication (NFC), etc., as suitable, and the user device may transmit the sensor data to the database 112 or the data processing device 114 via the network 108. In some examples, the wearable device 102 may directly transmit the sensor data to the database 112 or the data processing device 114 via the network 108.

As referred to herein, a user device may be any suitable computing device including but not limited to a mobile telephone (smartphone), laptop computer, tablet computer, desktop computer, server computer, personal computer, or any other mobile device capable of performing data processing. In some examples, the wearable device 102 and the user device are implemented as a single unit (e.g., in a single housing or casing) or separate units (e.g., different devices that are independently operable) as suitable.

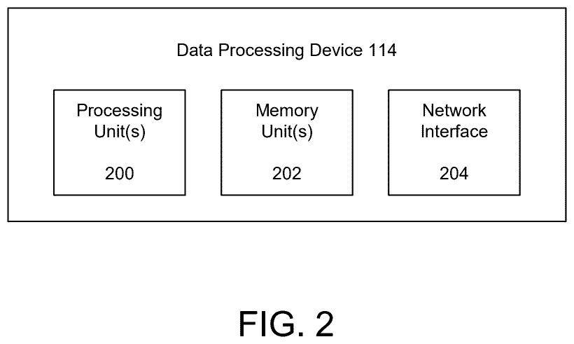

FIG. 2 shows an example of the components of a data processing device 114 according to embodiments disclosed herein. In some examples, the components may include a processing unit 200, a memory unit 202, and a network interface 204 to be operably coupled with the network 108. For example, the processing unit 200 may include one or more of: central processing unit (CPU), graphics processing unit (GPU), data processing unit (DPU), system on a chip (SoC), digital signal processor (DSP), general purpose microprocessor, application specific integrated circuit (ASIC), field programmable logic array (FPGA), and/or other equivalent integrated or discrete logic circuitry as suitable. For example, the memory unit 202 may be any suitable non-transitory computer readable storage medium or media including but not limited to read-only memory (ROM), random access memory (RAM), solid state drive (SSD), flash drive, compact disc (CD), laser disc, optical disc, digital versatile disc (DVD), floppy disk, and/or Blu-ray disc, as suitable. In some examples, the memory unit 202 (non-transitory computer readable medium) may store thereon instructions or program codes (computer program instructions) which, when executed by the processing unit 200 (processor), causes the processing unit 200 to perform any one or more of the processes disclosed herein. The network interface 206 facilitates secure connection with the network 108 such that communication over the network 108 is accomplished via the network interface 206 using any type of protocol, protection scheme, encoding, format, and/or packaging, as known in the art, to preserve patient data privacy and security.

The data processing device 114 is configured to execute a predictive model for predicting a fall event based at least on sensor data collected from a wearer of the device 102. The data processing device 114 uses both historical laboratory-collected data (such as historical laboratory-collected movement data) and historical community-collected data (such as historical community-collected movement data) associated with other users of the system and stored in database 112 to train and validate the at least one predictive model. In some examples, the historical laboratory-collected data may include at least one of: sensor recordings, demographics, and observer input. In some examples, the historical community-collected data may include at least one of: sensor recordings, demographics, and user self-reported input.

In some embodiments, once the model is trained, in operation, the predictive model may be embedded onto the wearable device's processing unit(s) and memory. A user's sensor data can be acquired by the sensor device 104 in both rehabilitation settings and community environments and used by the locally-stored trained predictive model to allow for continuous and rapid in situ fall prediction and mitigation. Identification of a fall and generation of instructions to deploy the airbag device can be executed entirely on the wearable device 102, allowing the system to make fast decisions without having to transmit data over the network 108. As such, system 100 may facilitate collection and processing of data and airbag deployment either in-person or remotely, thus making it capable of predicting and mitigating falls both in a laboratory or rehabilitation facility setting and in the community.

In some embodiments, the trained model may be stored locally on the wearable device 102 (e.g., on the second data processing device 114). In some examples, while the model is being trained, the model may be stored externally (e.g., on the first data processing device 114) such that the model currently being trained is not stored on the wearable device 102. Instead, in such examples, the sensor data is collected by the sensor device 104 and is transmitted from the wearable device 102 to a remote data system 110 for processing and model training. During model training, the wearable device 102 may not be integrated with any predictive model, or it may be integrated with an untrained, previously trained, or differently trained model. Once the model is trained, the trained model is transmitted to the wearable device 102 and is integrated into the wearable device 102, such as in a memory unit 202 associated with the data processing device 114 that is integrated in the wearable device 102. Subsequently, all model-based predictions (e.g., using the trained model as stored on the memory unit 202 integrated in the wearable device 102) and airbag deployment actions may be facilitated by the data processing device 114 of the wearable device 102.

During model training, sensor data is communicated to the data system 110, and the data processing device 114 then extracts features from the sensor data received from the sensor device indicative of a fall and predicts, using the trained and validated model, a fall event based on the extracted features. These extracted features include, but are not limited to, many descriptive statistics of the sensor data, including, but not limited to, maximum, minimum, measures of central tendency, measures of distribution shape, and correlation among signals. Once the model is trained, sensor data may be processed on a data processing device provided on or integral to the wearable device 102. If a fall is predicted, an instruction is generated by the data processing device 114 of the wearable device 102 to deploy the airbag device 106.

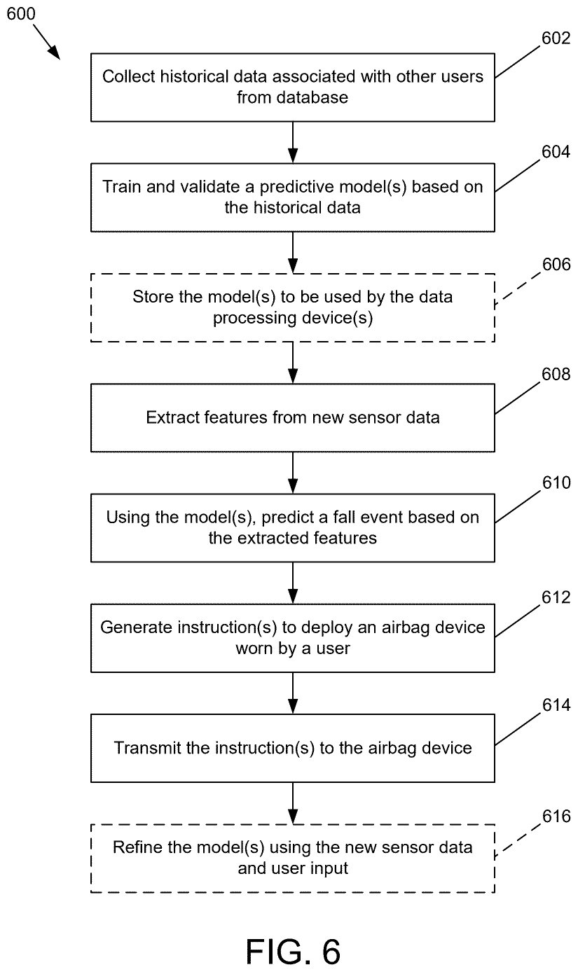

FIG. 6 shows a process 600 for pre-fall detection and mitigation which may be performed by one or more data processing devices 114 operatively coupled with the database 112 according to embodiments disclosed herein. In step 602, the device collects historical data associated with other patients from the database. The other patients may refer to patients not included in the patients wearing the sensor device as shown in FIG. 1. The historical data may include one or more types of data as collected in the past, including but not limited to past sensor recordings associated with the other patients, demographics of the other patients, user self-reported fall confirmation data (e.g., true fall or not fall; when, where, how fall occurred; any injuries sustained; if medical attention was sought) of the other patients and other observational data (e.g., for laboratory-collected data, observations may include the type of simulated activity performed by the patients—activity of daily living, near fall, fall, etc.). Additionally, the historical data may include laboratory data collected from other patients and community-based data collected from other patients. Further, the historical data may include data collected from one or more patient populations, including PD patients, post-stroke patients, older adult patients, and patients with other motor-neural impairments.

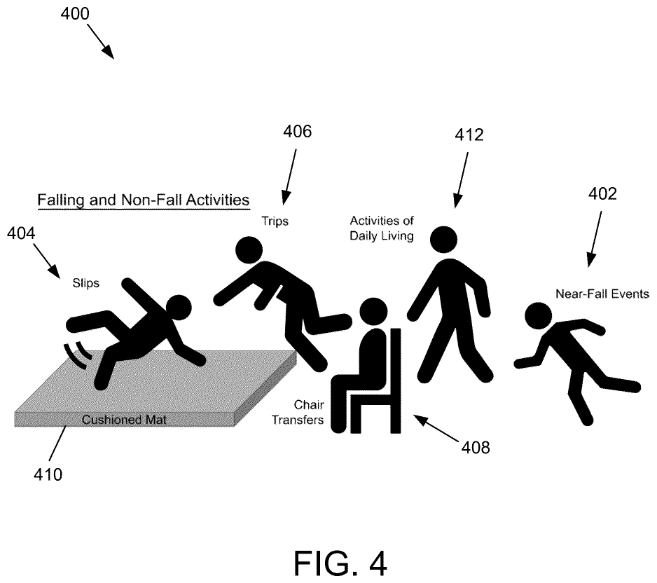

In one experimental example, in-laboratory data used to train the model was collected from 54 participants, including 20 with Parkinson's Disease (PD), 20 with stroke, and 14 healthy controls. Data was collected with an IMU sensor including an accelerometer (range ±16 g) and a gyroscope sensor (range ±2000 deg/s) that collect data in all three axes (x, y, and z) at a sampling rate of 500 Hz, positioned on the participant's lower back. FIG. 4 illustrates an example of experimental in-laboratory setup 400. During the in-laboratory sessions, subjects were outfitted in full-body padding with a helmet and performed intentional falls, activities of daily living 412 (e.g., walking, sitting, lying, sit-to-stands, jumping), and intentional near-fall 402 (e.g., slips 404, trips 406, and falls from chair 408) activities onto a padded mat 410. As in-laboratory data can be collected at relatively high numbers in a controlled environment, it may constitute the majority of a historical dataset used to train and validate the predictive model.

Real-world data used to train the model, in one experimental example, was collected from 20 participants, including 10 with PD and 10 with stroke. Over the course of six months, all participants wore a hip-protecting airbag system with embedded sensors, such as the Wolk BV wearable airbag system (shorts or hip belt), in the community. Participants were instructed to wear the airbag system as much as possible during waking hours. Data was collected with an IMU sensor having an accelerometer (range ±16 g) and a gyroscope sensor (range ±2000 deg/s) that collected data in all three axes (x, y, and z) at a sampling rate of 500 Hz, positioned on the lower back of a participant. At this stage, a basic fall detection algorithm integral to the WOLK wearable airbag system was used. WOLK's default fall detection algorithm analyzes the data recorded by its embedded sensors and attempts to start deploying airbags at least 100 ms before impact with the ground. If the system detected a fall, the airbags deployed and IMU sensor data was captured and recorded to an output file. Recorded fall data can be saved for later analysis and/or wirelessly transmitted in real time to a data system 110. After each data recording, the participant was contacted to provide the circumstances of the presumed fall (e.g., when, where, what part of body was impacted, any injuries, and if medical attention was necessary). Participants were also asked to confirm if the airbag deployment instance in question was truly a fall. The related sensor data was labelled accordingly as a true fall, or not, based on the participant's response. In some instances, an airbag deployment instance occurred due to non-fall events, such as running or dropping the device while changing clothing. These events were labeled as non falls and used in the development of the model. Furthermore, some participants self-reported that falls occurred while they were not wearing the device, therefore no IMU data was collected for these events. Both falls and non-falls are essential to build accurate machine learning algorithms. With data collected from both falls and non-falls, the prediction algorithms can be trained to instruct airbag deployment if, and only if, a fall occurs. In the extreme case, algorithm trained exclusively on falling data may interpret that every possible sensor reading will result in a fall, i.e., there will be many false positives. This would be a very ineffective system in practice. By additionally training the algorithm with non-fall data, in practice it will better identify sensor readings for true falls and will not instruct the airbags to deploy in non-fall situations. While this real-world dataset may be smaller than the in-laboratory set, it may provide vital information about naturally occurring falls in the stroke and PD populations.

Participants in the community-based data collection cohort were also asked to come into the laboratory for three different follow-up sessions, over the course of six months (enrollment, 3-month follow-up, 6-month follow-up). At these sessions, participants completed the 10 meter walk test (10MWT) (self selected, fast, and slow speeds), functional gait assessment (FGA), mini-BESTest, and MDS-Unified Parkinson's Disease Rating Scale (UPDRS) (PD subjects only). A series of questionnaires were also given to the participants, which included the modified falls efficacy scale (mFES), mini-mental status exam (MMSE), world health organization quality of life (WHOQOL-BREF), history of falls, and a customer user satisfaction survey. Data collected from these metrics may enable subsequent research on sub-groups within neurological populations. These data may allow us to discover trends where subjects with certain clinical exam scores may require different fall detection algorithms than the general population they come from (older adults, people with stroke, people with Parkinson's disease, etc.). These data are also useful for other basic science on falls and fall risk.

In step 604, the device trains and validates one or more predictive models based on the historical data. The historical data selected to train the model may be tailored to the patient population within which the system user is a member. For example, if the system user has experienced a stroke, the device may be trained and validated based on historical data collected from other post-stroke patients. The models may be trained such that each model predicts a fall prior to user impact with the ground.

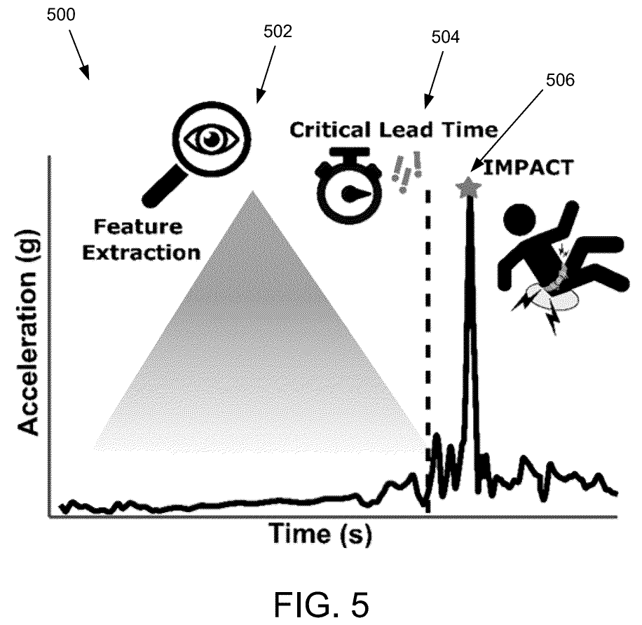

FIG. 5 illustrates how the machine-learning model may be trained on statistical features calculated from historical data leading up to the point of impact 506. For both in-laboratory and real-world historical data, the collected raw IMU data can be input to an automated, custom Python pipeline that included filtering and segmenting data. For example, collected raw IMU data can be filtered by a fourth-order band pass Butterworth filter (X-X). Fall data can be clipped to include a data window up to 100 ms before the point of impact. This limit may be based on airbag device lead time 504, which is the amount of time it may take for the algorithm to make a decision and deploy the airbags.

Impact times are traced on the acceleration data 500 by event markers in the lab-collected data and self-reports of the impact date and time by participants in the real-world data. The maximal acceleration value is marked as the actual impact onset for the fall events and theoretical impact onset for the non-fall events. For non-fall activities, including activities of daily living and near-fall events, theoretical impact timepoints may be marked to locate the point at which there would be the most movement. Then these windows of data may be treated the same as falls, but with different labels in the supervised machine learning process.

In some examples, features can be extracted via feature extraction 502 from multiple overlapping windows of pre-impact data, each less than a second in duration, starting from the impact point and counting backwards to build the fall prediction model. These features may be a mix of statistical time-domain features collected from each sensor signal. In total, over 100 features may be calculated. To reduce the number of features and only use the ones most important for developing a robust and accurate model, a hyperparameter tuning pipeline may be used for feature selection. This pipeline can remove features with values that did not change over time, features that were strongly correlated with one another, and features that are unimportant for the model's decision. The purpose of reducing the number of total features is to lessen the computational complexity of the machine-learning model for use in real-time situations.

In one experimental example, a 100 ms overlapping moving window was set starting at 400 ms before the impact moment. This window was moved at the increments of 50 ms, spanning from 400 ms to 200 ms before the impact onset. A total of five windows were recorded for each fall instance. Features were calculated and extracted from each window, including: root mean squared, velocity, jerk, maximum, absolute maximum, minimum, absolute minimum, median, standard deviation, skewness, kurtosis and interquartile range. For a general and computationally faster algorithm, in wearable devices having multiple IMU sensors, only features of one sensor, for example the center IMU, may be included in the prediction model.

Next, the final reduced feature set is input to a variety of machine learning algorithms, including AdaBoost, convolutional neural networks, and random forest models. To take advantage of the real-world historical dataset, several transfer-learning techniques can be used to leverage the relative prevalence and specificity of the two datasets (the in-laboratory data is plentiful but less specific to real-world fall detection, while the real-world dataset is smaller but very specific). These techniques include a custom version of synthetic minority oversampling. The model type and transfer learning method with the highest cross-validation performance, measured by F1 score, was chosen as the final model.

In one example, all processed features (n=X) were incorporated into a classification model. A random forest algorithm was selected over support vector machine (SVM) and neural network models due to its robustness in handling unbalanced data and lower computational cost. To explore differences in prediction accuracy between data collected in laboratory setting and real-world environments, three distinct models were applied to different segments of the dataset:
I) In-lab data model: Data collected in the lab were divided into training (16 participants) and testing (4 participants) sets, and grouped by participants. This model evaluated the performance of the fall detection algorithm solely on in-lab collected data.
II) Real-world data model: Data collected from real-world environments were split into training (7 participants) and testing (2 participants) sets, and grouped by participants. This model assessed the performance of the algorithm on real-world data.
III) Combined model: To evaluate the performance of the algorithm on prediction of two different environments, the model was trained on a combined dataset comprising in-lab (20 participants) and real-world (2 participants) dataset.

The performance and consistency of the first model were validated using cross-validation with 5 folds of the training dataset. For the latter two models, leave-two-out cross-validation was applied. The consistency of the F1 scores across all folds was assessed, and the average F1 value along with receiver operating characteristic curve (ROC) and area under the curve (AUC) were reported as the model's outcome. Due to the small real-world sample size (9), this group on the training set of the combined model was oversampled to 10% of the trained in-lab data using nominal-categorical SMOTE function. To ensure the best possible performance of each model, a feature selection pipeline was conducted using the LassoCV algorithm, and optimal parameters were selected to maximize the classification performance of the algorithm (measured by the F1-metric).

In step 606, which may be an optional step in some examples, the trained models may be stored in the database to be used by the data processing device(s) and/or the user device(s). For example, a data processing device may train a predictive model using the historical data such that other data processing devices or user devices may access the database to retrieve the trained model to use in the future, such that the devices (such as those with weaker processing capabilities) may still be able to use the pre-trained model without necessarily having the capability to train such models themselves.

In step 608, the data processing device (or, in some examples, the user device prior to transmitting the new sensor data to the data processing device) extracts features from the new sensor data that is obtained from the sensor device. For example, sensor data may be processed such that the resulting signals are cleaned, filtered/smoothened, and/or mathematically transformed in preparation for extracting signal characteristics that are subsequently used in the trained model. In some examples, the signal processing can take place in real-time to ensure accurate monitoring of signal quality and computation of simple metrics. In some examples, additional operations such as data segmentation and data transformation can be executed offline immediately after the recording process (that is, the process of recording the sensor data in the database). The signal processing step may be beneficial to systematically reduce noise and convert the raw sensor data into consistent, encodable values for analysis by the trained predictive model. Signal features extracted at this step, and ultimately utilized by the prediction model, may include root mean squared, velocity, jerk, maximum, absolute maximum, minimum, absolute minimum, median, standard deviation, skewness, kurtosis and interquartile range.

In step 610, the data processing device uses the trained predictive model(s) to predict a fall event based on the extracted features. As referred to herein, the predictive model may be any suitable model using artificial intelligence, such as machine learning, shallow learning, or deep learning, that is capable of being trained using existing or historical data and being used to make reliable predictions on current or future events based on learning a pattern from the training data. For example, deep learning techniques can be applied to teach a model to recognize and interpret characteristic acceleration patterns from IMU data to determine whether the wearer of the system is experiencing a fall.

In step 612, if the trained predictive models detect a fall event, the data processing device generates instructions to deploy an airbag device worn by a user. These instructions are transmitted to the airbag device in step 614. The transmission of such instructions may be performed similarly to the transmission of the sensor signal data, such that the airbag device is capable of receiving the instructions in response to the sensor data that was transmitted using the sensor device. In some examples, the airbag device that receives the instructions may be different from the sensor device that transmitted the sensor data.

Optionally, in step 616, the data processing device may refine the previously trained model(s) using the new sensor data and user input so as to improve the accuracy of future predictions performed by the same model(s). The prediction models may also be continuously updated by continuously collecting additional sensor data, for example as long as the user wears the wearable device 102. In some examples, step 614 may occur simultaneously with any one of the steps 608, 610, and 612. In some examples, step 616 may occur simultaneously with the database receiving the new sensor data from the sensor device. As used herein, “simultaneously” may also be referred to as “real-time” or “near real-time”, indicating that there is minimal time lag (for example, less than 1 minute, less than 30 seconds, less than 10 seconds, or less than 1 second, etc.) between two actions that are being performed.

In some examples, the entirety of the process 600 may be performed by a single data processing device. In some examples, the process 600 may be performed by two or more data processing devices such that each data processing device performs a different portion of the process 600 (for example, a first data processing device performs the model training and validation, while a second data processing device uses the trained and validated model to predict a fall event). In some examples, a portion of the process 600 may be performed by multiple data processing devices for redundancy in order to ensure accuracy or for backups.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A system for pre-fall detection and mitigation, the system comprising:
a data system comprising a database and at least one first data processing device, the first data processing device configured to:
collect historical laboratory-collected data and historical community-collected data associated with a plurality of users from the database; and
train and validate at least one predictive model based on the historical laboratory-collected data and the historical community-collected data; and
at least one wearable device attached noninvasively to a user, the wearable device comprising: at least one sensor device configured to continuously generate new sensor data associated with the user, at least one fall impact mitigation device, and at least one second data processing device, the second data processing device configured to:
extract features from the new sensor data generated by the sensor device;
predict, using the trained and validated model, a fall event based on the extracted features;
generate instructions to deploy the fall impact mitigation device; and
transmit the instructions to the fall impact mitigation device.

2. The system of claim 1, wherein the first data processing device is further configured to refine the trained and validated model using the new sensor data.

3. The system of claim 1, wherein the fall impact mitigation device is an inflatable airbag device.

4. The system of claim 1, wherein the new sensor data includes one or more types of biometric or activity data.

5. The system of claim 4, wherein the biometric or activity data includes motion data from one or more inertial measurement units (IMUs).

6. The system of claim 1, wherein the extracted features include one or more of: root mean squared, velocity, jerk, maximum, absolute maximum, minimum, absolute minimum, median, standard deviation, skewness, kurtosis, interquartile range, and correlation among signals.

7. The system of claim 1, wherein the historical laboratory-collected data comprises at least one of: sensor recordings, demographics, and observer input.

8. The system of claim 1, wherein the historical community-collected data comprises at least one of: sensor recordings, demographics, and user self-reported input.

9. A method for pre-fall detection and mitigation, the method comprising:
collecting historical data associated with a plurality of users from a database;
training and validating at least one predictive model based on the historical data;
extracting features from new sensor data received from at least one wearable sensor device attached noninvasively to a user, the sensor device configured to continuously generate the new sensor data associated with the user;
predicting, using the trained and validated model, a fall event based on the extracted features;
generating instructions to deploy a fall impact mitigation device attached noninvasively to the user; and
transmitting the instructions to the fall impact mitigation device.

10. The method of claim 9, further comprising: storing the trained and validated model in the database to be used by one or more data processing devices.

11. The method of claim 9, further comprising: refining the trained and validated model using the new sensor data.

12. The method of claim 9, wherein the fall impact mitigation device is an inflatable airbag device.

13. The method of claim 9, wherein the new sensor data includes one or more types of biometric or activity data.

14. The method of claim 13, wherein the biometric or activity data includes motion data from one or more inertial measurement units (IMUs).

15. A non-transitory computer readable medium storing computer program instructions that, when executed by a processor, cause the processor to:
receive new sensor data from at least one wearable sensor device attached noninvasively to a user, the sensor device configured to continuously generate the new sensor data associated with the user;
extract features from the new sensor data;
predict, using at least one predictive model trained and validated based on historical data associated with a plurality of users collected from a database, a fall event based on the extracted features;
generate instructions to deploy a fall impact mitigation device attached noninvasively to the user; and
transmit the instructions to the fall impact mitigation device.

16. The non-transitory computer readable medium of claim 15, wherein the computer program instructions further cause the processor to: store the trained and validated model in the database to be used by one or more data processing devices.

17. The non-transitory computer readable medium of claim 15, wherein the computer program instructions further cause the processor to: transmit the new sensor data to at least one external data processing device to refine the trained and validated model using the new sensor data.

18. The non-transitory computer readable medium of claim 15, wherein the fall impact mitigation device is an inflatable airbag device.

19. The non-transitory computer readable medium of claim 15, wherein the new sensor data includes one or more types of biometric or activity data.

20. The non-transitory computer readable medium of claim 19, wherein the biometric or activity data includes motion data from one or more inertial measurement units (IMUs).
